(19) United States
(12) Patent Application Publication
(10) Pub. No.: US 2025/0277931 A1
(43) Pub. Date: Sep. 4, 2025

(54) MULTICORE FIBER

(71) Applicant: FURUKAWA ELECTRIC CO., LTD., Tokyo (JP)

(72) Inventors: Yusuke MATSUNO, Tokyo (JP); Mitsuhiro IWAYA, Tokyo (JP); Ken SEIMIYA, Tokyo (JP); Kuniaki ISHIZUKI, Tokyo (JP); Masanori TAKAHASHI, Tokyo (JP); Ryuichi SUGIZAKI, Tokyo (JP); Yoshihiro ARASHITANI, Tokyo (JP)

(73) Assignee: FURUKAWA ELECTRIC CO., LTD., Tokyo (JP)

(21) Appl. No.: 19/062,483

(22) Filed: Feb. 25, 2025

(30) Foreign Application Priority Data
Mar. 1, 2024 (JP) 2024-030968
Jan. 14, 2025 (JP) 2025-004497

(51) Int. Cl. G02B 6/02

(52) U.S. Cl. CPC G02B 6/02042; G02B 6/02395

(57) ABSTRACT

A multicore fiber includes: core portions; a cladding portion surrounding each core portion; a primary layer surrounding the cladding portion; and a secondary layer surrounding the primary layer. When Δ denotes a maximum relative refractive-index difference of the core portions from an average refractive index of the cladding portion, Δ is in a range of 0.2% to 0.5%, inclusive, a core diameter of each core portion is in a range of 4.0 μm to 15 μm, inclusive, a cladding diameter of the cladding portion is 125 μm or larger, a ratio of a thickness of the primary layer to a thickness of the secondary layer is 0.35 or smaller, a cut-off wavelength measured with a fiber length shorter than 2 meters is smaller than 1530 nm, and a cut-off wavelength measured with the fiber length is 1260 nm or larger.

This application claims the benefit of priority from Japanese Patent Application No. 2024-030968 filed on Mar. 1, 2024 and Japanese Patent Application No. 2025-004497 filed on Jan. 14, 2025, the entire contents of which are incorporated herein by reference.

### BACKGROUND

The present disclosure relates to a multicore fiber.

Optical fibers are often used for purposes requiring a long fiber length such as communication lines. In contrast, when optical fibers are used as an optical component part or as an optical fiber provided in an optical component part, the optical fiber may have a short fiber length. Further, because information communication is getting to be performed in a larger volume due to the development of Internet of Things (IoT) in recent years, a multicore fiber may be used for a wiring within a communication apparatus. Also when such a multicore fiber is used for a wiring within a communication apparatus, the fiber length is relatively short.

ITU-T G.650.1 of the International Telecommunication Union (ITU) defines cut-off wavelengths of optical fibers according to characteristics measured by setting the fiber length thereof to be 2 meters (hereinafter, “2 m”). However, as mentioned above, optical fibers may be used while the fiber length is shorter than 2 m, in some situations. For shorter optical fibers like in those situations, the cut-off wavelength thereof shifts toward a longer wavelength, as compared to the situation where the fiber length is 2 m. As a result, in some situations, those optical fibers may accidentally become multi-mode fibers in a desired wavelength band.

A useful method for preventing an optical fiber from accidentally becoming a multi-mode fiber is to inhibit propagation in high-order modes. As for techniques for inhibiting optical fibers from propagating in the high-order modes, known examples include a technique using a trench structure, as disclosed in Japanese Patent Application Laid-open No. 2008-310328, for example.

Further, in some situations, multicore fibers may present a problem of crosstalk between a plurality of core portions. To solve the problem of crosstalk also, a trench structure may be used (Japanese Patent Application Laid-open No. 2013-54252, for example).

### SUMMARY

Japanese Patent Application Laid-open No. 2008-310328 adopts a complicated trench structure, which involves difficult designing and manufacturing. Further, in the example of a multicore fiber such as that disclosed in Japanese Patent Application Laid-open No. 2013-54252, a problem may arise in some situations where, if a trench structure is adopted, the cut-off wavelength shifts toward a longer wavelength, especially in a core portion positioned close to the central axis of a cladding portion. Further, although Japanese Patent Application Laid-open No. 2013-54252 describes inhibiting propagation in high-order modes, by increasing the refractive index of core portions, it is anticipated that crosstalk may be worsened due to the increased refractive index. Accordingly, it is necessary to design a refractive index while crosstalk is taken into consideration, which may narrow the range of designs.

There is a need for a multicore fiber capable of inhibiting propagation in the high-order modes even when the fiber length is short.

According to one aspect of the present disclosure, there is provided a multicore fiber including: a plurality of core portions made of glass; a cladding portion made of glass and surrounding an outer periphery of each of the plurality of core portions; a primary layer made of resin and surrounding an outer periphery of the cladding portion; and a secondary layer made of resin and surrounding an outer periphery of the primary layer, wherein when Δ denotes a maximum relative refractive-index difference of the core portions from an average refractive index of the cladding portion, Δ is in a range of 0.2% to 0.5%, inclusive, a core diameter of each of the core portions is in a range of 4.0 μm to 15 μm, inclusive, a cladding diameter of the cladding portion is 125 μm or larger, a ratio of a thickness of the primary layer to a thickness of the secondary layer is 0.35 or smaller, a cut-off wavelength measured with a fiber length shorter than 2 meters is smaller than 1530 nm, and a cut-off wavelength measured with the fiber length is 1260 nm or larger.

According to another aspect of the present disclosure, there is provided a multicore fiber including: a plurality of core portions made of glass; a cladding portion made of glass and surrounding an outer periphery of each of the plurality of core portions; a primary layer made of resin and surrounding an outer periphery of the cladding portion; and a secondary layer made of resin and surrounding an outer periphery of the primary layer, wherein when Δ denotes a maximum relative refractive-index difference of the core portions from an average refractive index of the cladding portion, Δ is in a range of 0.2% to 0.5%, inclusive, a core diameter of each of the core portions is in a range of 4.0 μm to 15 μm, inclusive, a cladding diameter of the cladding portion is 125 μm or larger, a ratio of a thickness of the primary layer to a thickness of the secondary layer is 0.35 or smaller, a cut-off wavelength measured with a fiber length shorter than 2 meters is smaller than 1260 nm, and a cut-off wavelength measured with the fiber length is 990 nm or larger.

According to still another aspect of the present disclosure, there is provided a multicore fiber including: a plurality of core portions made of glass; a cladding portion made of glass and surrounding an outer periphery of each of the plurality of core portions; a primary layer made of resin and surrounding an outer periphery of the cladding portion; and a secondary layer made of resin and surrounding an outer periphery of the primary layer, wherein when Δ denotes a maximum relative refractive-index difference of the core portions from an average refractive index of the cladding portion, Δ is in a range of 0.2% to 0.5%, inclusive, a core diameter of each of the core portions is in a range of 4.0 μm to 15 μm, inclusive, a cladding diameter of the cladding portion is 125 μm or larger, a ratio of a thickness of the primary layer to a thickness of the secondary layer is 0.35 or smaller, a cut-off wavelength measured with a fiber length shorter than 2 meters is smaller than 1565 nm, and a cut-off wavelength measured with the fiber length is 1295 nm or larger.

### BRIEF DESCRIPTION OF THE DRAWINGS

FIG. 1 is a schematic cross-sectional view of a multicore fiber according to a first embodiment;

FIG. 2 is a chart illustrating an example of a relationship between core diameters and relative refractive-index differences A;

FIG. 3 is a chart illustrating an example of a relationship between Primary/Secondary (P/S) thickness ratios and relative microbending (MB) sensitivities;

FIG. 4 is a chart illustrating another example of the relationship between P/S thickness ratios and relative MB sensitivities;

FIG. 5 is a chart illustrating yet another example of the relationship between P/S thickness ratios and relative MB sensitivities;

FIG. 6 is a chart illustrating an example of a relationship between primary elastic moduli and primary diameters;

FIG. 7 is a chart illustrating another example of the relationship between primary elastic moduli and primary diameters;

FIG. 8 is a chart illustrating yet another example of the relationship between primary elastic moduli and primary diameters;

FIG. 9 is a chart illustrating yet another example of the relationship between primary elastic moduli and primary diameters;

FIG. 10 is a chart illustrating yet another example of the relationship between primary elastic moduli and primary diameters;

FIG. 11 is a chart illustrating an example of a relationship between primary elastic moduli and P/S thickness ratios;

FIG. 12 is a chart illustrating another example of the relationship between core diameters and relative refractive-index differences A;

FIG. 13 is a chart illustrating yet another example of the relationship between core diameters and relative refractive-index differences A; and

FIG. 14 is a schematic cross-sectional view of a multicore fiber according to a second embodiment.

### DETAILED DESCRIPTION

Exemplary embodiments of the present disclosure will be explained in detail below, with reference to the accompanying drawings. It should be noted that the present disclosure is not limited by the embodiments described below. Further, in the drawings, some of the constituent elements that are the same as, or that correspond to each other will be referred to by using the same reference characters, as appropriate. Furthermore, terms that are not particularly defined in the present disclosure are in accordance with the definitions and the measuring methods set forth in G.650.1 and G.650.2.

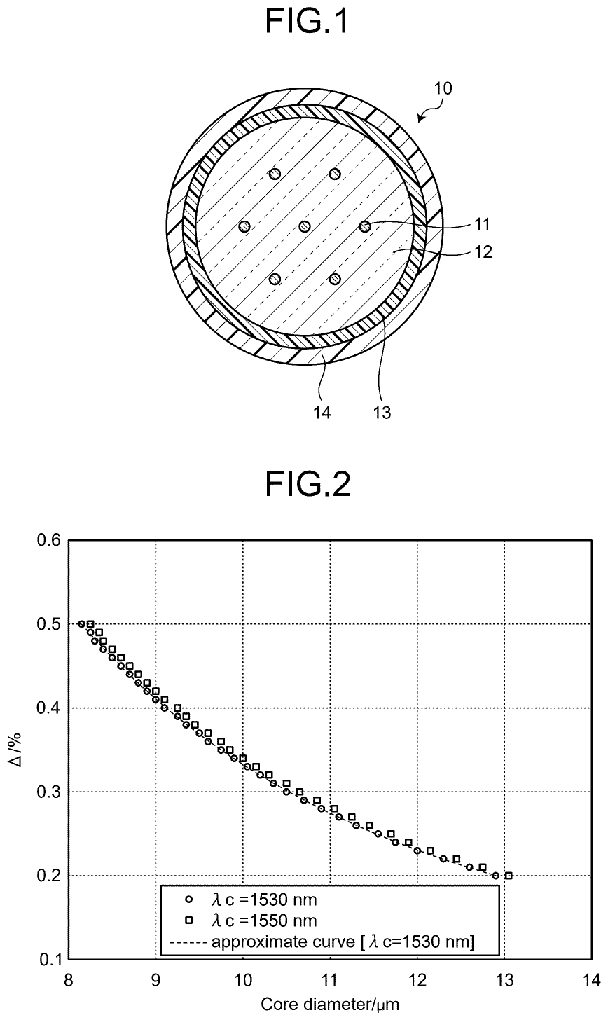

FIG. 1 is a schematic cross-sectional view of a multicore fiber according to a first embodiment. A multicore fiber 10 includes: seven core portions 11 made of glass such as quartz-based glass; a cladding portion 12 made of glass such as quartz-based glass and surrounding the outer periphery of each of the core portions 11; a primary layer 13 made of resin and surrounding the outer periphery of the cladding portion 12; and a secondary layer 14 made of resin and surrounding the outer periphery of the primary layer 13. In the present embodiment, the core portions 11 are arranged so as to form a triangular lattice.

The seven core portions 11 include two types of core portions, namely: one first core portion positioned substantially at the center of the cladding portion 12 and is thus positioned closer to the center; and six second core portions surrounding the first core portion while each being positioned more distant from the center.

The part including the core portions 11 and the cladding portion 12 is a part made of glass in the multicore fiber 10 and may be referred to as a glass optical fiber. Further, the primary layer 13 and the secondary layer 14 may be referred to as covering layers. The multicore fiber including the covering layers may be referred to as a multicore fiber element wire.

The glass optical fiber of the multicore fiber 10 may have, for example, a refractive index profile of a step index type. However, the refractive index profile of the glass optical fiber may be another refractive index profile, such as a profile of a W type or a trench type. Further, in the present disclosure, a relative refractive-index difference (a maximum relative refractive-index difference) of a maximum refractive index of the core portions 11 from an average refractive index of the cladding portion 12 will be expressed as Δ. In the present embodiment, Δ is in the range of 0.2% to 0.5%, inclusive. Further, the core diameter of each of the core portions 11 is in the range of 4.0 μm to 15 μm, inclusive. The outside diameter (a cladding diameter) of the cladding portion 12 is 125 μm or larger. The distance (which may be called a core pitch) between the centers of any two adjacently-positioned core portions 11 may be, for example 5.80 μm, but is not limited to this value.

The resin used for structuring the primary layer 13 and the secondary layer 14 may be an ultraviolet curable resin, for example. The ultraviolet curable resin may be obtained by combining together, for example, various types of resin materials and additives, such as an oligomer, a diluent monomer, a photopolymerization initiator, a silane coupling agent, a sensitizer, a lubricant, and the like. As the oligomer, it is acceptable to use any of the materials that are hitherto known publicly, such as a polyether-based urethane acrylate, an epoxy acrylate, a polyester acrylate, a silicone acrylate, and the like. As the diluent monomer, it is acceptable to use any of the materials that are hitherto known publicly, such as a monofunctional monomer, a multi-functional monomer, and the like. Further, possible examples of the additives are not limited to those listed above, and it is acceptable to generally use any of the additives and the like that are hitherto known publicly and have been used in ultraviolet curable resins and the like.

An elastic modulus of the primary layer 13 called a primary elastic modulus is smaller than an elastic modulus of the secondary layer 14 called a secondary elastic modulus. The secondary elastic modulus may be in the range of, for example, 500 MPa to 1000 MPa, inclusive. The primary elastic modulus and the secondary elastic modulus may each be referred to as Young's modulus. It is possible to realize those elastic moduli, by adjusting components of the resin, manufacturing conditions, and the like. More specifically, it is possible to adjust the primary elastic modulus and the secondary elastic modulus by varying, among the materials used for structuring the primary layer 13 and the secondary layer 14, the type, the molecular weight, and the content amount of the oligomer, the type and the added amount of the diluent monomer, and/or the types and the content amounts of other components, as well as curing conditions such as the irradiation intensity of ultraviolet rays and/or the like.

With regard to the multicore fiber 10 structured as described above, it is desirable to have the following characteristics: the ratio of the thickness of the primary layer 13 to the thickness of the secondary layer 14, i.e., “the thickness of the primary layer”/“the thickness of the secondary layer” is 0.35 or smaller; a cut-off wavelength measured with a fiber length shorter than 2 m is smaller than 1530 nm; and the cut-off wavelength measured with the aforementioned fiber length is 1260 nm or larger. When the multicore fiber 10 has the above characteristics, because propagation in the high-order modes is inhibited even when the fiber length is shorter than 2 m, it is possible to transmit light having a wavelength in the range of 1530 nm to 1565 nm (called the C-band) in a single mode.

In this situation, the cut-off wavelength measured with a fiber length shorter than 2 m denotes a cut-off wavelength obtained by referring to the cut-off wavelength measuring method defined in ITU-T G.650.1 and implementing the measuring method while changing only the length of the measured optical fiber to a fiber length shorter than 2 m.

Next, specific explanations will be provided. To begin with, to inhibit the propagation in the high-order modes, the inventors of the present disclosure explored characteristics of the cut-off wavelength (which hereinafter may be referred to as a “2-m cut-off wavelength”) based on characteristics that were measured while the fiber length was set to 2 m as defined in ITU-T G.650.1.

FIG. 2 is a chart illustrating an example of a relationship between core diameters and relative refractive-index differences (Δ) that make the 2-m cut-off wavelength (λc) equal to either 1530 nm or 1550 nm, with respect to a glass optical fiber having a refractive index profile of a step index type. In the present example, FIG. 2 illustrates results of a simulation calculation using a weak guidance approximation. Further, in FIG. 2, the broken line is an approximate curve of data points using a quartic function corresponding to λc being equal to 1530 nm. The approximate curve was expressed as y=0.0001x⁴−0.0063x³+0.1235x²−1.1514x+4.531 (r2=0.9999), where x denotes the core diameter, whereas y denotes the relative refractive-index difference. Accordingly, we confirmed that the 2-m cut-off wavelength is smaller than 1530 nm, when y<0.0001x⁴−0.0063x³+0.1235x²−1.1514x+4.531 is satisfied.

However, as mentioned above, regarding optical fibers, when the fiber length is shorter than 2 m, the cut-off wavelength shifts toward a longer wavelength, as compared to the 2-m cut-off wavelength. Thus, even when the 2-m cut-off wavelength is smaller than 1530 nm, a cut-off wavelength may be 1530 nm or larger in some situations. In addition, when the refractive index profile is of the W type or the trench type mentioned above, there may be some situations in which, due to a low refraction region included in the core portions, the high-mode propagation can easily occur in the core portion positioned closer to the center of the cladding portion. In other words, there may be some situations in which a multi-mode propagation state can easily be achieved due to the shifting of the cut-off wavelength toward a longer wavelength. To cope with this situation, the present inventors conceived of a technical idea by which, when the fiber length is short such as less than 2 m, microbending loss caused by covering layers is increased by adjusting characteristics of the covering layers, so as to increase propagation loss in the high-order modes and to thereby inhibit the propagation. This technical idea is greatly different from the common technical idea believing that such microbending loss caused by the covering layers should be inhibited from increasing whenever possible.

The present inventors conducted a study on microbending loss sensitivities “φbend” as an index of an increase in the microbending loss. In the following sections, the microbending loss sensitivities may be referred to as MB loss sensitivities.

For example, it is possible to express φbend by using the expressions presented below, according to J. Baldauf, N. Okada, and M. Miyamoto, “Relationship of mechanical characteristics of dual coated single mode optical fibers and microbending loss”, IEICE Trans. Commun., vol. E76-B, no. 4, pp. 352-357, 1993.

$$φ bend = 3 {f}_{0} {x}_{s}^{2} / ( {H}_{g}^{2} {D}_{0}^{0.375} {H}_{s}^{0.625} )$$

$${f}_{0} = {τ}_{w} / {r}_{D}$$

$${H}_{g} = π {E}_{g} {r}_{g}^{4} / 4$$

$${D}_{0} = {E}_{p} + {{E}_{s} ( {r}_{s} - {r}_{p} )}^{3} / {r}_{s}^{3}$$

$${H}_{s} = π {E}_{s} ( {r}_{s}^{4} - {r}_{p}^{4} ) / 4$$

$${x}_{s} = {E}_{p} {r}_{g} / ( {r}_{p} - {r}_{g} )$$

In the above, E_{g} denotes the elastic modulus of the cladding portion; Eₚ denotes the primary elastic modulus; Eₛ denotes the secondary elastic modulus; r_{g} denotes a half of the outside diameter of the cladding portion (½ of the cladding diameter); rₚ denotes a half of the outside diameter of the primary layer (½ of the primary diameter); rₛ denotes a half of the outside diameter of the secondary layer (½ of the secondary diameter); r_{D} denotes a drum radius (=0.3 m); and τ_{w} denotes a winding tension (=10 N).

Further, an optical fiber used as a reference for the MB loss sensitivities will be referred to as a reference optical fiber. The reference optical fiber includes a reference core portion made of glass; a reference cladding portion made of glass and surrounding the outer periphery of the reference core portion; a reference primary layer made of resin and surrounding the outer periphery of the reference cladding portion; and a reference secondary layer made of resin and surrounding the outer periphery of the reference primary layer. Of the reference optical fiber, the cladding diameter is 125 μm; the primary diameter is 195 μm; the secondary diameter is 250 μm; the elastic modulus of the reference cladding portion is 70000 MPa; the primary elastic modulus is 0.5 MPa; and the secondary elastic modulus is 1000 MPa. An MB loss sensitivity of the reference optical fiber will be referred to as a reference MB sensitivity φbend_ref. Further, the present inventors discovered the following: when R (=φbend_s/φbend_ref, i.e., a relative MB loss sensitivity) denotes the ratio of an MB loss sensitivity φbend_s of an optical fiber of interest to φbend_ref, if R is equal to 1, the microbending loss is so small and is therefore negligible; however, if R is 2 or larger, there is large microbending loss, which is effective in inhibiting the propagation in the high-order modes, i.e., in inhibiting the cut-off wavelength from shifting toward a longer wavelength.

Subsequently, with respect to the multicore fiber 10 illustrated in FIG. 1, the present inventors conducted a study on optimal values of a Primary/Secondary thickness ratio (hereinafter, “P/S thickness ratio”) calculated as “the thickness of the primary layer”/“the thickness of the secondary layer”, in relation to various sets each made up of a cladding diameter (GD) and a secondary diameter (SD), as presented in Table 1. More specifically, the cladding diameters (GD) used in the study were 125 μm, 150 μm, 180 μm, 210 μm, and 250 μm.

TABLE 1

| No. | 1 | 2 | 3 | 4 | 5 | 6 | 7 | 8 | 9 | 10 | 11 | 12 |
|---|---|---|---|---|---|---|---|---|---|---|---|---|
| GD | 125 | 125 | 150 | 150 | 150 | 180 | 180 | 180 | 210 | 210 | 250 | 250 |
| [μm] | | | | | | | | | | | | |
| SD | 200 | 250 | 200 | 250 | 300 | 250 | 300 | 350 | 300 | 350 | 300 | 350 |
| [μm] | | | | | | | | | | | | |

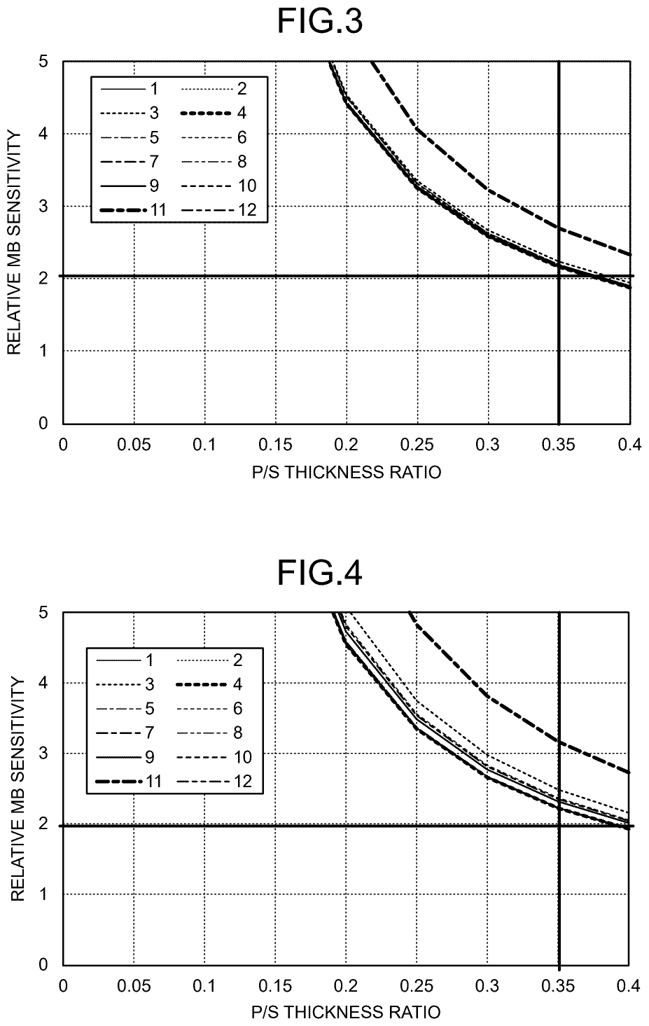

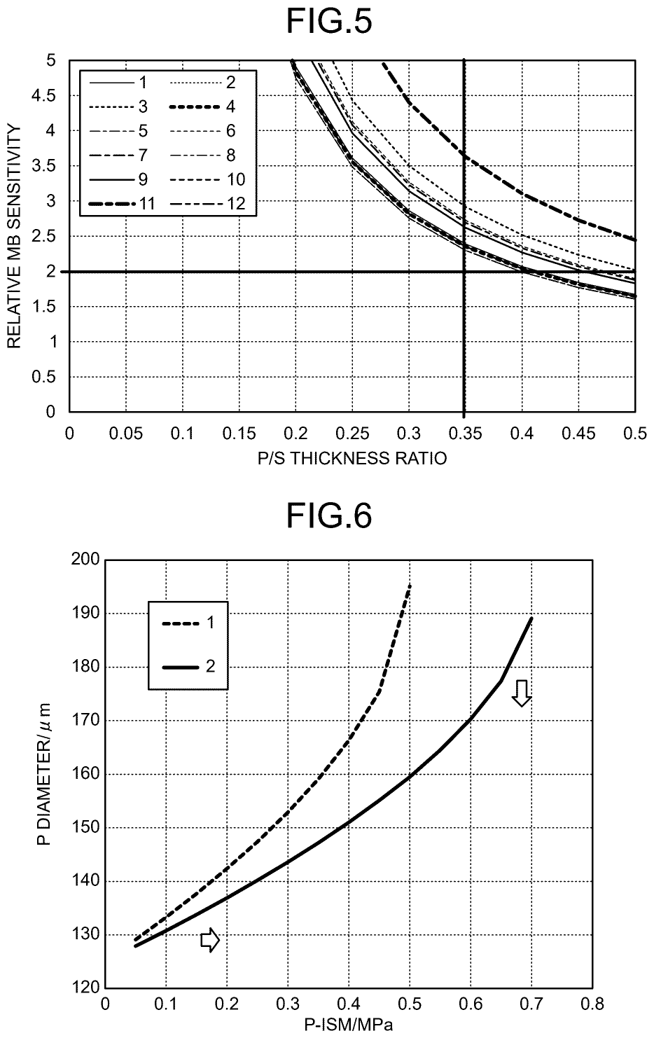

FIG. 3 is a chart illustrating an example of a relationship between P/S thickness ratios and relative MB sensitivities, with a primary elastic modulus of 0.5 MPa and a secondary elastic modulus of 1000 MPa. FIG. 4 is a chart illustrating another example of the relationship between P/S thickness ratios and relative MB sensitivities, with a primary elastic modulus of 1.0 MPa and a secondary elastic modulus of 1000 MPa. FIG. 5 is a chart illustrating yet another example of the relationship between P/S thickness ratios and relative MB sensitivities, with a primary elastic modulus of 2.0 MPa and a secondary elastic modulus of 1000 MPa. In this situation, the numbers in the legends of FIGS. 3 to 5 correspond to the data numbers in Table 1. As illustrated in FIGS. 3 to 5, from the present inventors' study, it was learned that, with respect to the various sets made up of the GD and SD values and the primary elastic moduli, to make the value of R equal to or larger than 2, it is preferable to have a P/S thickness ratio of 0.35 or smaller. In addition, it was also learned that it is more preferable to have a P/S thickness ratio smaller than 0.3, and it is even more preferable to have a P/S thickness ratio smaller than 0.25. Furthermore, the present inventors conducted a study on a relationship between primary elastic moduli and values of R, while setting various P/S thickness ratios and learned that, to make the value of R equal to or larger than 2, it is more desirable to have a primary elastic modulus of 0.75 MPa or larger.

Subsequently, the present inventors conducted a study on a relationship between primary elastic moduli and primary diameters. FIG. 6 is a chart illustrating, with respect to the multicore fiber 10 illustrated in FIG. 1, an example of the relationship between primary elastic moduli and primary diameters, with a cladding diameter of 125 μm, a secondary diameter of 250 μm, and a secondary elastic modulus of 1000 MPa. In FIG. 6, “P-ISM” on the horizontal axis denotes the primary elastic moduli, whereas “P diameters” on the vertical axis denotes the primary diameters. Further, the broken line represents values corresponding to R=1, whereas the solid line represents values corresponding to R=2. In FIG. 6, the region to the lower right of the solid line indicated by the arrows represents conditions that satisfy the requirement of R being equal to or larger than 2. Further, by expressing the solid line with an approximate curve using a quartic function, y=587.69x⁴−682x³+295.88x²+13.713x+126.81 (r2=0.9996) was obtained, where x denotes the primary elastic modulus, whereas y denotes the primary diameter. Accordingly, we confirmed it is possible to make the value of R equal to or larger than 2 when y≤587.69x⁴−682x³+295.88x²+13.713x+126.81 is satisfied. For example, when R=2 is true, the primary diameter falls in the range of 128 μm to 190 μm, for instance. In that situation, the thickness of the primary layer (the primary thickness) falls in the range of 1.5 μm to 32.5 μm, whereas the thickness of the secondary layer (the secondary thickness) falls in the range of 30 μm to 61 μm.

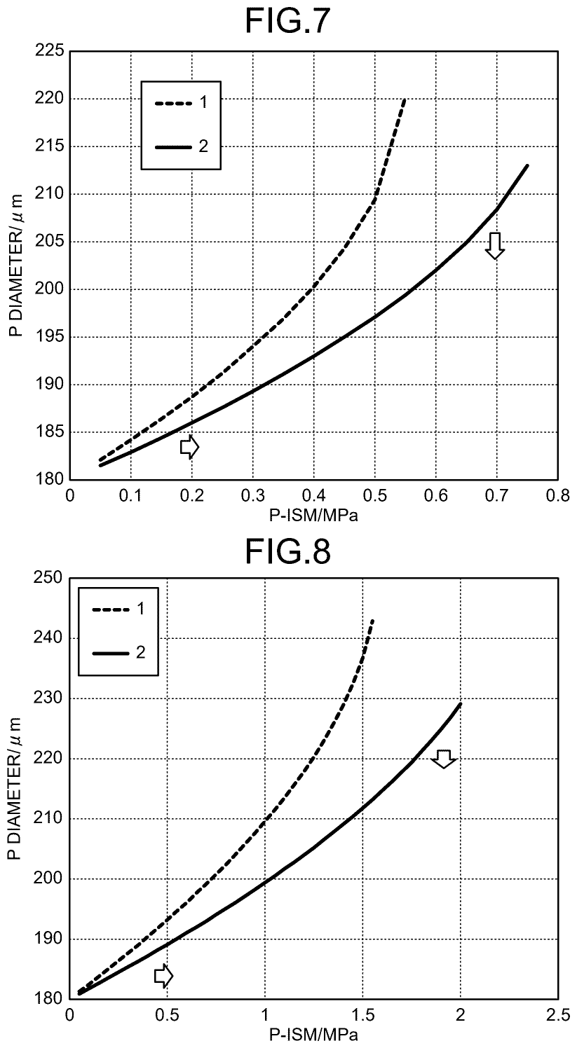

Next, FIG. 7 is a chart illustrating, with respect to the multicore fiber 10 illustrated in FIG. 1, another example of the relationship between primary elastic moduli and primary diameters, with a cladding diameter of 180 μm, a secondary diameter of 250 μm, and a secondary elastic modulus of 1000 MPa. In FIG. 7, “P-ISM” on the horizontal axis denotes the primary elastic moduli, whereas “P diameters” on the vertical axis denotes the primary diameters. Further, the broken line represents values corresponding to R=1, whereas the solid line represents values corresponding to R=2. In FIG. 7, the region to the lower right of the solid line indicated by the arrows represents conditions that satisfy the requirement of R being equal to or larger than 2. Further, by expressing the solid line with an approximate curve using a quartic function, y=135.14x⁴−158.37x³+78.077x²+16.624x+180.55 (r2=0.9999) was obtained, where x denotes the primary elastic modulus, whereas y denotes the primary diameter. Accordingly, we confirmed it is possible to make the value of R equal to or larger than 2, when y≤135.14x⁴−158.37x³+78.077x²+16.624x+180.55 is satisfied. For example, when R=2 is true, the primary diameter falls in the range of 183 μm to 213 μm, for instance. In that situation, the primary thickness falls in the range of 1.5 μm to 16.5 μm, whereas the thickness of the secondary layer falls in the range of 8.5 μm to 33.5 μm.

Next, FIG. 8 is a chart illustrating, with respect to the multicore fiber 10 illustrated in FIG. 1, another example of the relationship between primary elastic moduli and primary diameters, with a cladding diameter of 180 μm, a secondary diameter of 300 μm, and a secondary elastic modulus of 1000 MPa. In FIG. 8, “P-ISM” on the horizontal axis denotes the primary elastic moduli, whereas “P diameters” on the vertical axis denotes the primary diameters. Further, the broken line represents values corresponding to R=1, whereas the solid line represents values corresponding to R=2. In FIG. 8, the region to the lower right of the solid line indicated by the arrows represents conditions that satisfy the requirement of R being equal to or larger than 2. Further, by expressing the solid line with an approximate curve using a quartic function, y=1.3726x⁴−3.1534x³+5.0183x²+15.993x+180.17 (r2=1) was obtained, where x denotes the primary elastic modulus, whereas y denotes the primary diameter. Accordingly, we confirmed it is possible to make the value of R equal to or larger than 2, when y≤1.3726x⁴−3.1534x³+5.0183x²+15.993x+180.17 is satisfied. For example, when R=2 is true, the primary diameter falls in the range of 181 μm to 229 μm, for instance. In that situation, the primary thickness falls in the range of 0.5 μm to 24.5 μm, whereas the thickness of the secondary layer falls in the range of 35.5 μm to 59.5 μm.

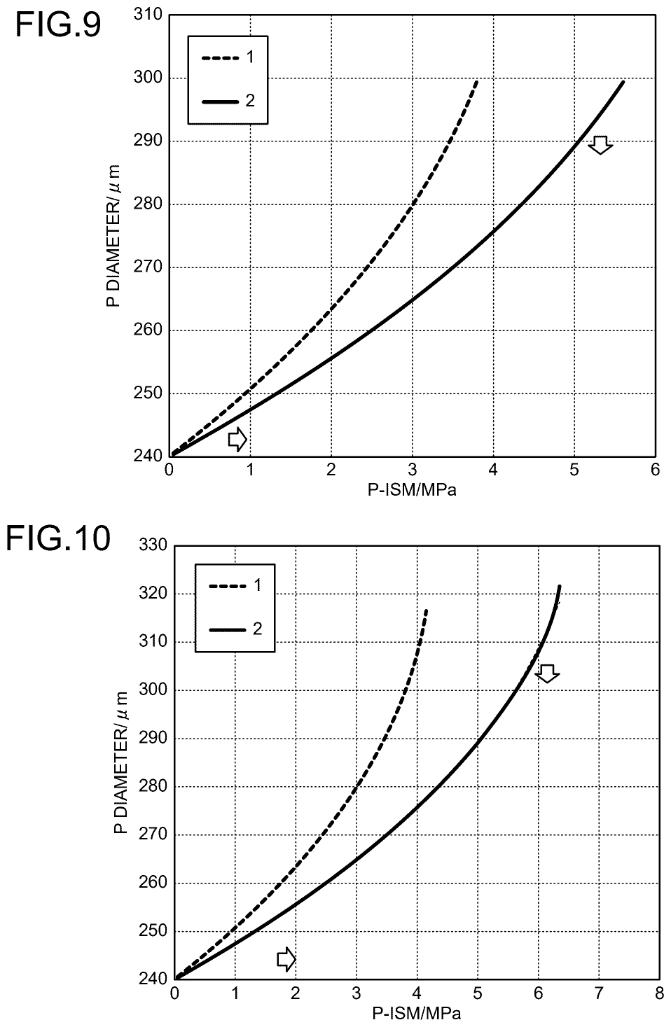

Next, FIG. 9 is a chart illustrating, with respect to the multicore fiber 10 illustrated in FIG. 1, another example of the relationship between primary elastic moduli and primary diameters, with a cladding diameter of 240 μm, a secondary diameter of 300 μm, and a secondary elastic modulus of 1000 MPa. In FIG. 9, “P-ISM” on the horizontal axis denotes the primary elastic moduli, whereas “P diameters” on the vertical axis denotes the primary diameters. Further, the broken line represents values corresponding to R=1, whereas the solid line represents values corresponding to R=2. In FIG. 9, the region to the lower right of the solid line indicated by the arrows represents conditions that satisfy the requirement of R being equal to or larger than 2. Further, by expressing the solid line with an approximate curve using a quartic function, y=0.0229x⁴−0.1312x³+0.7097x²+6.6821x+240.14 (r2=1) was obtained, where x denotes the primary elastic modulus, whereas y denotes the primary diameter. Accordingly, we confirmed it is possible to make the value of R equal to or larger than 2, when y≤0.0229x⁴−0.1312x³+0.7097x²+6.6821x+240.14 is satisfied. For example, when R=2 is true, the primary diameter falls in the range of 241 μm to 299 μm, for instance. In that situation, the primary thickness falls in the range of 0.5 μm to 29.5 μm, whereas the thickness of the secondary layer falls in the range of 0.5 μm to 29.5 μm.

Next, FIG. 10 is a chart illustrating, with respect to the multicore fiber 10 illustrated in FIG. 1, another example of the relationship between primary elastic moduli and primary diameters, with a cladding diameter of 240 μm, a secondary diameter of 350 μm, and a secondary elastic modulus of 1000 MPa. In FIG. 10, “P-ISM” on the horizontal axis denotes the primary elastic moduli, whereas “P diameters” on the vertical axis denotes the primary diameters. Further, the broken line represents values corresponding to R=1, whereas the solid line represents values corresponding to R=2. In FIG. 10, the region to the lower right of the solid line indicated by the arrows represents conditions that satisfy the requirement of R being equal to or larger than 2. Further, by expressing the solid line with an approximate curve using a quartic function, y=0.0669x⁴−0.6164x³+2.4088x²+4.6485x+240.69 (r2=0.9996) was obtained, where x denotes the primary elastic modulus, whereas y denotes the primary diameter. Accordingly, we confirmed it is possible to make the value of R equal to or larger than 2, when y≤0.0669x⁴−0.6164x³+2.4088x²+4.6485x+240.69 is satisfied. For example, when R=2 is true, the primary diameter falls in the range of 240 μm to 322 μm, for instance. In that situation, the primary thickness falls in the range of 0 μm to 41 μm, whereas the thickness of the secondary layer falls in the range of 14 μm to 55 μm.

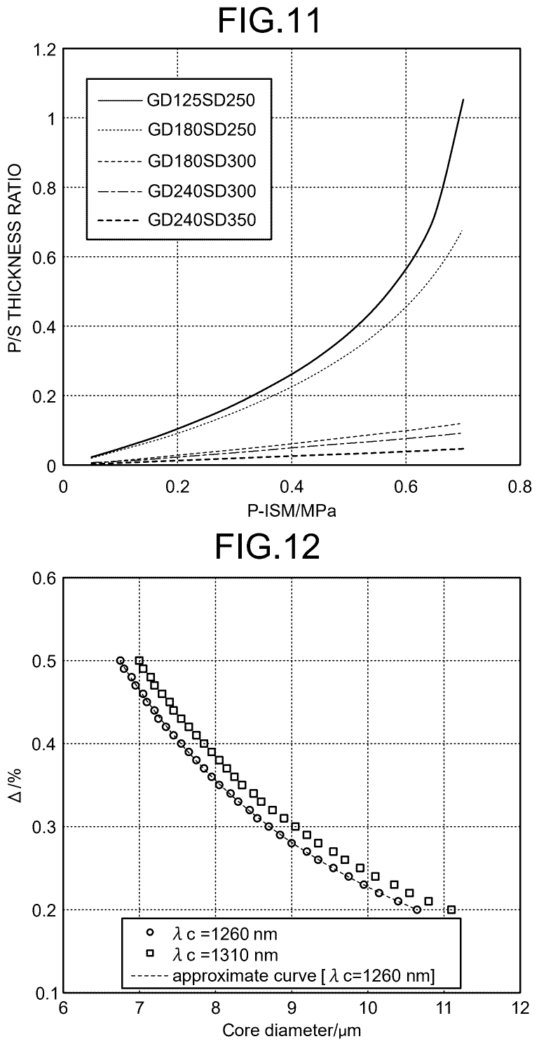

FIG. 11 is a chart illustrating an example of a relationship between primary elastic moduli (P-ISM) (MPa) and P/S thickness ratios. FIG. 11 illustrates examples where R=2 is true with respect to sets each made up of a GD (the cladding diameter) value and an SD (the secondary diameter) value such as those presented in Table 1. For example, “GD125SD250” denotes a cladding diameter of 125 μm and a secondary diameter of 250 μm. In this situation, the secondary elastic modulus is set to 1000 MPa. It is possible to make the value of R equal to 2, by using the sets each made up of a primary elastic modulus and a P/S thickness ratio that are represented by the different types of lines in FIG. 11.

Table 2 presents, in relation to FIG. 6, examples of R values obtained by appropriately setting the cladding diameter, the primary diameter, the secondary diameter, the primary elastic modulus, and the secondary elastic modulus. it is understood that, with any of the examples presented in Table 2, it is possible to make the value of R equal to or larger than 2. In contrast, Table 3 presents an example in which R is equal to 1. In this example, it is not possible to achieve the advantageous effect of inhibiting the propagation in the high-order modes.

TABLE 2

| | | | Primary | Secondary | |
|---|---|---|---|---|---|
| Cladding | Primary | Secondary | elastic | elastic | |
| diameter | diameter | diameter | modulus | modulus | |
| [μm] | [μm] | [μm] | [MPa] | [MPa] | R |
| 125 | 189 | 250 | 0.7 | 1000 | 2 |
| 125 | 178 | 250 | 0.8 | 1000 | 3 |
| 125 | 175 | 250 | 0.9 | 1000 | 4 |

TABLE 3

| | | | Primary | Secondary | |
|---|---|---|---|---|---|
| Cladding | Primary | Secondary | elastic | elastic | |
| diameter | diameter | diameter | modulus | modulus | |
| [μm] | [μm] | [μm] | [MPa] | [MPa] | R |
| 125 | 195 | 250 | 0.5 | 1000 | 1 |

Further, as explained above, with respect to the multicore fiber 10 according to the first embodiment, a preferable lower limit value for the cut-off wavelength measured with a fiber length shorter than 2 m is 1260 nm. The reasons is that, when the fiber length is shortened by 0.5 m, the cut-off wavelength of an optical fiber may shift toward a longer wavelength by 90 nm (for example, Louis-Anne de Montmorillon et al., “Recent Developments of Bend-insensitive and Ultra-bend-insensitive Fibers Fully Compliant with Both G.657.B and G.652. D ITU-T Recommendations”, Proceedings of the 58th IWCS/IICIT, International Wire & Cable Symposium, pp. 270-276). Accordingly, in order to ensure that light having a wavelength of 1530 nm is transmitted in the single mode, even when the multicore fiber 10 according to the first embodiment is used in a certain fiber length shorter than 0.5 m, it is required that the cut-off wavelength measured with the same fiber length is 1260 nm or larger, because (1530 nm−90 nm×3)=1260 nm.

### First Modification Example of First Embodiment

The multicore fiber 10 according to the first embodiment is configured to inhibit the propagation in the high-order modes even when the fiber length is shorter than 2 m. It is therefore possible to transmit light having a wavelength in the range of 1530 nm to 1565 nm (called the C-band) in the single mode. In contrast, a multicore fiber according to a first modification example of the first embodiment is configured so as to be able to inhibit the propagation in the high-order modes even when the fiber length is shorter than 2 m and to transmit light having a wavelength in the range of 1260 nm to 1360 nm (called the O-band) in the single mode.

For example, the multicore fiber according to the first modification example of the first embodiment includes a plurality of core portions, a cladding portion, a primary layer, and a secondary layer that are similar to those of the multicore fiber 10. In this situation, Δ is in the range of 0.2% to 0.5%, inclusive; the core diameter is in the range of 4.0 μm to 15 μm, inclusive; the cladding diameter is 125 μm or larger; the ratio calculated as “the thickness of the primary layer”/“the thickness of the secondary layer” is 0.35 or smaller; the cut-off wavelength measured with a fiber length shorter than 2 m is smaller than 1260 nm; and the cut-off wavelength measured with the aforementioned fiber length is 990 nm or larger. In this example, the lower limit value 990 nm is a value derived by calculating: (1260 nm−270 nm)=990 nm.

FIG. 12 is a chart illustrating an example of a relationship between core diameters and relative refractive-index differences (Δ) that make the 2-m cut-off wavelength (λc) equal to either 1260 nm or 1310 nm, with respect to a glass optical fiber having a refractive index profile of a step index type. In the present example, FIG. 12 illustrates results of a simulation calculation using a weak guidance approximation. Further, in FIG. 12, the broken line is an approximate curve of data points using a quartic function corresponding to λc being equal to 1260 nm. The approximate curve was expressed as y=0.0002x⁴−0.0101x³+0.1701x²−1.3472x+4.466 (r2=0.9998), where x denotes the core diameter, whereas y denotes the relative refractive-index difference. Accordingly, we confirmed that the 2-m cut-off wavelength is smaller than 1260 nm, when y<0.0002x⁴−0.0101x³+0.1701x²−1.3472x+4.466 is satisfied.

### Second Modification Example of First Embodiment

A multicore fiber according to a second modification example of the first embodiment is configured so as to be able to inhibit the propagation in the high-order modes even when the fiber length is shorter than 2 m and to transmit light having a wavelength in the range of 1565 nm to 1625 nm (called the L-band) in the single mode.

For example, the multicore fiber according to the second modification example of the first embodiment includes a plurality of core portions, a cladding portion, a primary layer, and a secondary layer that are similar to those of the multicore fiber 10. In this situation, Δ is in the range of 0.2% to 0.5%, inclusive; the core diameter is in the range of 4.0 μm to 15 μm, inclusive; the cladding diameter is 125 μm or larger; the ratio calculated as “the thickness of the primary layer”/“the thickness of the secondary layer” is 0.35 or smaller; the cut-off wavelength measured with a fiber length shorter than 2 m is smaller than 1565 nm; and the cut-off wavelength measured with the aforementioned fiber length is 1295 nm or larger. In this example, the lower limit value 1295 nm is a value derived by calculating: (1565 nm−270 nm)=1295 nm.

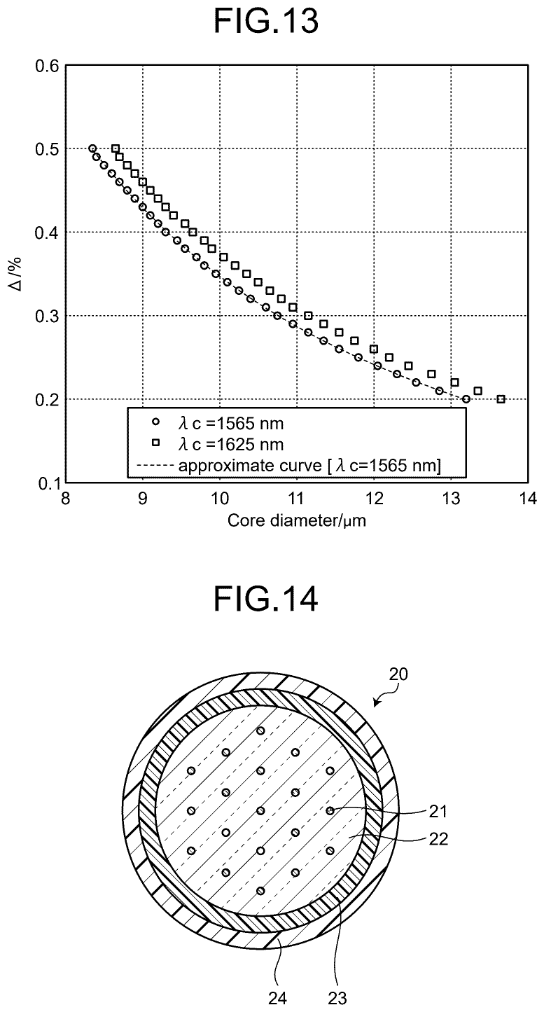

FIG. 13 is a chart illustrating yet another example of the relationship between core diameters and relative refractive-index differences (Δ) that make the 2-m cut-off wavelength (λc) equal to either 1565 nm or 1625 nm, with respect to a glass optical fiber having a refractive index profile of a step index type. In the present example, FIG. 13 illustrates results of a simulation calculation using a weak guidance approximation. Further, in FIG. 13, the broken line is an approximate curve of data points using a quartic function corresponding to λc being equal to 1565 nm. The approximate curve was expressed as y=0.00008x⁴−0.0045x³+0.0991x²−1.0101x+4.276 (+2=0.9999), where x denotes the core diameter, whereas y denotes the relative refractive-index difference. Accordingly, we confirmed that the 2-m cut-off wavelength is smaller than 1565 nm, when y≥0.00008x⁴−0.0045x³+0.0991x²−1.0101x+4.276 is satisfied.

FIG. 14 is a schematic cross-sectional view of a multicore fiber according to a second embodiment. A multicore fiber 20 includes: nineteen core portions 21 made of glass such as quartz-based glass; a cladding portion 22 made of glass such as quartz-based glass and surrounding the outer periphery of each of the core portions 21; a primary layer 23 made of resin and surrounding the outer periphery of the cladding portion 22; and a secondary layer 24 made of resin and surrounding the outer periphery of the primary layer 23. In the present embodiment, the core portions 21 are arranged so as to form a triangular lattice. The nineteen core portions 21 include three types of core portions, namely: one first core portion positioned substantially at the center of the cladding portion 22 and is thus positioned closer to the center; six second core portions surrounding the first core portion while each being positioned more distant from the center; and twelve third core portions that are positioned even more distant from the center than the second core portions are. The multicore fiber 20 is an example of a multicore fiber including two or more types of core portions positioned distant from the center of the cladding portion 22.

The core portions 21, the cladding portion 22, the primary layer 23, and the secondary layer 24 are configured by using the same materials and have the same characteristics, respectively, as those of the corresponding elements in the multicore fiber 10 according to the first embodiment illustrated in FIG. 1. Thus, detailed explanations thereof will be omitted. Also when the multicore fiber 20 having the nineteen core portions 21 is used, as long as the ratio calculated as “the thickness of the primary layer”/“the thickness of the secondary layer” is 0.35 or smaller, while the cut-off wavelength measured with a fiber length shorter than 2 m is smaller than 1530 nm and is equal to or larger than 1260 nm, it is possible to transmit light having a wavelength in the C-band by using the single mode even when the fiber length is shorter than 2 m.

Further, in a first modification example of the second embodiment, as long as the ratio calculated as “the thickness of the primary layer”/“the thickness of the secondary layer” is 0.35 or smaller, while the cut-off wavelength measured with a fiber length shorter than 2 m is smaller than 1260 nm and is equal to or larger than 990 nm, it is possible to transmit light having a wavelength in the O-band by using the single mode even when the fiber length is shorter than 2 m.

Further, in a second modification example of the second embodiment, as long as the ratio calculated as “the thickness of the primary layer”/“the thickness of the secondary layer” is 0.35 or smaller, while the cut-off wavelength measured with a fiber length shorter than 2 m is smaller than 1565 nm and is equal to or larger than 1295 nm, it is possible to transmit light having a wavelength in the L-band by using the single mode even when the fiber length is shorter than 2 m.

In the embodiments described above, the quantity of the core portions is either seven or nineteen; however, the quantity of the core portions is not limited to these examples. Also, possible positional arrangements of the core portions are not limited to the triangular lattices, either.

According to at least one aspect of the present disclosure, an advantageous effect is achieved where it is possible to realize a multicore fiber capable of inhibiting propagation in the high-order modes even when the fiber length is short.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A multicore fiber comprising:
a plurality of core portions made of glass;
a cladding portion made of glass and surrounding an outer periphery of each of the plurality of core portions;
a primary layer made of resin and surrounding an outer periphery of the cladding portion; and
a secondary layer made of resin and surrounding an outer periphery of the primary layer, wherein
when Δ denotes a maximum relative refractive-index difference of the core portions from an average refractive index of the cladding portion, Δ is in a range of 0.2% to 0.5%, inclusive,
a core diameter of each of the core portions is in a range of 4.0 μm to 15 μm, inclusive,
a cladding diameter of the cladding portion is 125 μm or larger,
a ratio of a thickness of the primary layer to a thickness of the secondary layer is 0.35 or smaller,
a cut-off wavelength measured with a fiber length shorter than 2 meters is smaller than 1530 nm, and
a cut-off wavelength measured with the fiber length is 1260 nm or larger.

2. The multicore fiber according to claim 1, wherein an elastic modulus of the primary layer is 0.75 MPa or larger.

3. The multicore fiber according to claim 1, wherein the fiber length is shorter than 2 meters.

4. The multicore fiber according to claim 1, wherein the ratio is smaller than 0.3.

5. The multicore fiber according to claim 1, wherein the ratio is smaller than 0.25.

6. The multicore fiber according to claim 1, wherein
a ratio of a microbending loss sensitivity thereof to a microbending loss sensitivity of the following is 2 or larger:
a reference optical fiber including a reference core portion made of glass, a reference cladding portion made of glass and surrounding an outer periphery of the reference core portion, a reference primary layer made of resin and surrounding an outer periphery of the reference cladding portion, and a reference secondary layer made of resin and surrounding an outer periphery of the reference primary layer, while a cladding diameter of the reference cladding portion is 125 μm; an elastic modulus of the reference cladding portion is 70000 MPa; an elastic modulus of the reference primary layer is 0.5 MPa; and an elastic modulus of the reference secondary layer is 1000 MPa.

7. A multicore fiber comprising:
a plurality of core portions made of glass;
a cladding portion made of glass and surrounding an outer periphery of each of the plurality of core portions;
a primary layer made of resin and surrounding an outer periphery of the cladding portion; and
a secondary layer made of resin and surrounding an outer periphery of the primary layer, wherein
when Δ denotes a maximum relative refractive-index difference of the core portions from an average refractive index of the cladding portion, Δ is in a range of 0.2% to 0.5%, inclusive,
a core diameter of each of the core portions is in a range of 4.0 μm to 15 μm, inclusive,
a cladding diameter of the cladding portion is 125 μm or larger,
a ratio of a thickness of the primary layer to a thickness of the secondary layer is 0.35 or smaller,
a cut-off wavelength measured with a fiber length shorter than 2 meters is smaller than 1260 nm, and
a cut-off wavelength measured with the fiber length is 990 nm or larger.

8. The multicore fiber according to claim 7, wherein an elastic modulus of the primary layer is 0.75 MPa or larger.

9. The multicore fiber according to claim 7, wherein the fiber length is shorter than 2 meters.

10. The multicore fiber according to claim 7, wherein the ratio is smaller than 0.3.

11. The multicore fiber according to claim 7, wherein the ratio is smaller than 0.25.

12. The multicore fiber according to claim 7, wherein
a ratio of a microbending loss sensitivity thereof to a microbending loss sensitivity of the following is 2 or larger:
a reference optical fiber including a reference core portion made of glass, a reference cladding portion made of glass and surrounding an outer periphery of the reference core portion, a reference primary layer made of resin and surrounding an outer periphery of the reference cladding portion, and a reference secondary layer made of resin and surrounding an outer periphery of the reference primary layer, while a cladding diameter of the reference cladding portion is 125 μm; an elastic modulus of the reference cladding portion is 70000 MPa; an elastic modulus of the reference primary layer is 0.5 MPa; and an elastic modulus of the reference secondary layer is 1000 MPa.

13. A multicore fiber comprising:
a plurality of core portions made of glass;
a cladding portion made of glass and surrounding an outer periphery of each of the plurality of core portions;
a primary layer made of resin and surrounding an outer periphery of the cladding portion; and
a secondary layer made of resin and surrounding an outer periphery of the primary layer, wherein
when Δ denotes a maximum relative refractive-index difference of the core portions from an average refractive index of the cladding portion, Δ is in a range of 0.2% to 0.5%, inclusive,
a core diameter of each of the core portions is in a range of 4.0 μm to 15 μm, inclusive,
a cladding diameter of the cladding portion is 125 μm or larger,
a ratio of a thickness of the primary layer to a thickness of the secondary layer is 0.35 or smaller,
a cut-off wavelength measured with a fiber length shorter than 2 meters is smaller than 1565 nm, and
a cut-off wavelength measured with the fiber length is 1295 nm or larger.

14. The multicore fiber according to claim 13, wherein an elastic modulus of the primary layer is 0.75 MPa or larger

15. The multicore fiber according to claim 13, wherein the fiber length is shorter than 2 meters.

16. The multicore fiber according to claim 13, wherein the ratio is smaller than 0.3.

17. The multicore fiber according to claim 13, wherein the ratio is smaller than 0.25.

18. The multicore fiber according to claim 13, wherein
a ratio of a microbending loss sensitivity thereof to a microbending loss sensitivity of the following is 2 or larger:
a reference optical fiber including a reference core portion made of glass, a reference cladding portion made of glass and surrounding an outer periphery of the reference core portion, a reference primary layer made of resin and surrounding an outer periphery of the reference cladding portion, and a reference secondary layer made of resin and surrounding an outer periphery of the reference primary layer, while a cladding diameter of the reference cladding portion is 125 μm; an elastic modulus of the reference cladding portion is 70000 MPa; an elastic modulus of the reference primary layer is 0.5 MPa; and an elastic modulus of the reference secondary layer is 1000 MPa.
